(19) United States
(12) Patent Application Publication
(10) Pub. No.: US 2026/0257393 A1
(43) Pub. Date: Sep. 3, 2026

(54) Battery-Operated Power Tool

(71) Applicant: Robert Bosch GmbH, Stuttgart (DE)

(72) Inventors: Caroline Kohler, Plieningen (DE); Robert Rampp, Illertissen (DE); Simon Riggenmann, Stuttgart (DE); Sven Neudoerffer, Weinstadt (DE)

(21) Appl. No.: 19/553,714

(22) Filed: Mar. 2, 2026

(30) Foreign Application Priority Data
Mar. 3, 2025 (DE) 10 2025 107 886.6

(51) Int. Cl. B27B 5/32; B27B 9/00

(52) U.S. Cl. CPC B27B 5/32; B27B 9/00

(57) ABSTRACT

A battery-powered power tool, in particular a circular saw, is disclosed with at least one battery interface, with at least one spindle, which is provided for receiving a tool, and with at least one locking unit for locking the at least one spindle. The locking unit includes at least one locking element to lock or unlock the at least one spindle. The locking unit further includes at least one actuating element arranged at the battery interface to move the at least one locking element.

This application claims priority under 35 U.S.C. § 119 to patent application no. DE 10 2025 107 886.6, filed on Mar. 3, 2025 in Germany, the disclosure of which is incorporated herein by reference in its entirety.

### BACKGROUND

A battery-operated power tool, in particular a circular saw, having at least one battery interface, with at least one spindle, which is provided for receiving a tool, and with at least one locking unit for locking the at least one spindle, wherein the locking unit comprises at least one locking element to lock or release the at least one spindle, and wherein the locking unit comprises at least one manually actuatable actuating element to move the at least one locking element, has been proposed in the prior art.

### SUMMARY

The disclosure relates to a battery-operated power tool, in particular circular saw, with at least one battery interface, with at least one spindle, which is provided for receiving a tool, and with at least one locking unit for locking the at least one spindle, wherein the locking unit comprises at least one locking element to lock or unlock the at least one spindle.

It is proposed that the locking unit comprises at least one actuating element arranged at the battery interface to move the at least one locking element.

Preferably, the power tool is configured as a cutting tool and/or grinding tool. For example, the power tool is configured as a circular saw, in particular as a hand circular saw or a table circular saw or a chop saw or a miter saw or a router or an edge router, or as an angle grinder or the like. The battery-operated power tool is preferably also configured to operate when wired in addition to being battery operated.

Preferably, the power tool comprises a drive unit. The drive unit is connected to a power supply, preferably at the battery interface. Preferably, the drive unit comprises at least one motor, which is in particular an electric motor. Preferably, the drive unit, in particular the motor, is provided for driving the at least one spindle indirectly or directly. Preferably, the at least one spindle is configured as a motor shaft or as a drive shaft. Preferably, the at least one spindle comprises a spindle axis. Preferably, the tool is fixable to the at least one spindle. In particular, the at least one spindle is provided for a rotationally fixed connection with the tool. The spindle is preferably provided for a releasable connection to the tool. The spindle preferably comprises at least one connecting element, preferably a form-fitting and/or frictionally fitting element. The spindle is, for example, provided for, without being limited thereto, establishing a screw connection and/or a plug connection and/or a latch connection and/or a clamp connection and/or another connection to the tool that appears to be useful to a person skilled in the art. The tool is provided to be driven by the power tool in at least one operating state of the power tool, thereby processing a workpiece upon direct contact with the workpiece.

Preferably, the at least one spindle is provided for transmitting a movement, in particular a rotational movement about the spindle axis, of the drive unit to the tool in one operating mode of the power tool.

The at least one locking unit is preferably provided to lock the at least one spindle of the power tool for a tool change. Preferably, the at least one locking element is provided for locking the at least one spindle, in particular with preventing rotational movement of the spindle about the spindle axis, when in a lock position. Preferably, the at least one locking element is provided for releasing the at least one spindle, in particular allowing rotational movement of the spindle about the spindle axis, when in an unlock position. The at least one actuating element is preferably provided to move the at least one locking element to the lock position or the unlock position.

Preferably, the battery interface is provided to receive a battery, in particular a battery compatible with the power tool, for supplying electrical energy. Preferably, the at least one actuating element is provided for moving the at least one locking element to the unlock position upon insertion of the battery into the at least one battery interface. Preferably, the at least one actuating element is provided for moving the at least one locking element to the lock position upon removal of the battery from the at least one battery interface. Preferably, the at least one actuating element is arranged on the battery interface such that the actuating element is actuatable by way of at least one outer surface of the battery. Preferably, the at least one actuating element at least partially protrudes from the battery interface for actuation by way of the battery.

In the following sections, the phrase “the actuating element at least partially protrudes from the battery interface” should be understood in particular to mean that at least 2%, advantageously at least 10%, preferably at least 15%, particularly preferably at least 20%, and particularly advantageously at least 25% of a total volume of the actuating element, in particular of a smallest imagined cuboid, which just completely encloses the actuating element, protrudes over a bottom surface of the battery interface.

“Provided” is to be understood in particular as specifically designed and/or equipped.

In particular, “provided for a specific function” is provided to be understood to mean that the object fulfills and/or performs this specific function in at least one in-use state and/or operating state.

The battery-operated power tool in accordance with the disclosure can provide an advantageously high degree of safety, because the at least one spindle is in particular automatically locked if no battery is inserted in the battery interface. In particular, the at least one spindle can advantageously only be locked for a tool change if no battery is inserted in the battery interface. In particular, a risk of accidental energizing of the power tool during a tool change may be advantageously kept low, which in particular may provide advantageously high operational safety for an operator. Furthermore, an advantageously high ease of use may be facilitated, in particular since no manual actuation of the actuation element is required.

It is further suggested that the locking unit comprises at least one latching element, in particular on the at least one spindle, corresponding to the at least one locking element. Preferably, the latching element is provided, together with the at least one locking element, for locking the at least one spindle when the at least one locking element is in the lock position. Preferably, the at least one locking element comprises at least one latch tab. Preferably, the at least one latching element comprises at least one, advantageously at least two, particularly advantageously at least four, preferably at least six latch openings. Preferably, the at least one latch tab of the at least one locking element is provided for latching into the at least one latch opening of the at least one latching element when in the lock position, in order to in particular lock the at least one spindle. Preferably, the at least one latching element is arranged in a rotationally fixed manner on the at least one spindle, in particular by way of a frictional connection or a form-fitting connection or a material closure connection. Alternatively, it is conceivable that the at least one spindle or the drive unit comprises at least one gear wheel for transmitting movement, wherein the at least one gear wheel forms the at least one latching element. By way of the embodiment according to the disclosure, an advantageously high user friendliness can be provided, because in particular advantageously precise locking of the at least one spindle can be enabled.

It is further proposed that the locking unit comprises at least one spring element coupled to the at least one locking element and provided for holding the at least one locking element in a lock position, in particular the one mentioned above. Preferably, the at least one spring element is arranged on the at least one locking element. Preferably, the at least one spring element is provided to move or retain the at least one locking element, particularly by way of a spring force, to/in the lock position upon removal of the battery from the at least one battery interface. Preferably, the at least one spring element is configured as, particularly a metallic, spiral spring, compression spring, or the like. By way of the embodiment according to the disclosure, an advantageously low design cost can be enabled to provide, in particular, an automatic locking of the at least one spindle when removing the battery from the battery interface.

Furthermore, it is proposed that the locking unit comprises a pulley system and/or a lever system, by way of which the at least one actuating element and the at least one locking element are coupled. The pulley system and/or the lever system is provided to transmit the movement of the actuating element to the locking element upon movement of the battery. Preferably, the pulley system is configured as a Bowden cable or the like. Preferably, the lever system for movement transmission comprises a plurality of levers, for example at least two levers, which are connected to one another via hinges. Alternatively, it is conceivable that the locking unit comprises a hydraulic transmission system or pneumatic transmission system, by way of which the at least one actuating element and the at least one locking element are coupled. By way of the design according to the disclosure, an advantageously high degree of flexibility can be provided with regard to the construction, since movements can in particular be transmitted over greater distances.

It is further suggested that the at least one locking element and the at least one actuating element are rigidly connected, in particular being formed from one piece. In particular, “one piece” is to be understood as being formed in one piece. Preferably, this one piece is produced from a single blank, a mass and/or a casting, more preferably in an injection-molding process, in particular, a single-and/or multi-component injection-molding process. As a result of the design according to the disclosure, an advantageously low number of components can be provided. Furthermore, an advantageously simple design of the movement transmission can be enabled, since in particular the movement is directly transmitted from the actuating element to the locking element.

It is further suggested that the locking unit comprises at least one further spring element, which is provided to effect a spring force contrary to a provided insertion direction of a battery in the battery interface. Preferably, the at least one further spring element is coupled to the at least one actuating element. Preferably, the at least one further spring element is arranged on the at least one actuating element. Preferably, the at least one further spring element is configured as, in particular, a metallic, spiral spring, compression spring, or the like. By way of the embodiment according to the disclosure, an advantageously high user comfort can be provided, since in particular the removal of the battery from the battery interface is supported by way of the spring force.

Furthermore, it is proposed that the at least one actuating element is configured as a lever and comprises a pivot axis aligned in parallel with a, in particular the aforementioned, spindle axis of the at least one spindle, or comprises a pivot axis aligned perpendicularly to the provided insertion direction of a battery in the battery interface and to the spindle axis. By way of the design according to the disclosure, an advantageously high degree of flexibility can be enabled with regard to the design, since the actuating element can be configured as a horizontally or vertically oriented lever, in particular depending on the space conditions of the power tool.

It is further suggested that the at least one actuating element is configured as an axial slider, which is movably mounted in the battery interface in an axis parallel to a provided insertion direction of a battery. By way of the design according to the disclosure, an advantageously space-saving construction of the power tool can be provided, because the axial slider in particular requires little space. Preferably, the axial slider is configured as a guided rod or pin. Alternatively, it is conceivable that the axial slider is configured as a sliding plate.

It is further suggested that the at least one actuating element is configured as a pressure switch. By way of the embodiment according to the disclosure, an advantageously simple design can be provided. Preferably, the at least one actuating element is configured as a mechanical pressure switch. For example, the mechanical pressure switch is configured as a spring return button or a spring-loaded push rod switch.

Furthermore, it is proposed that the at least one actuating element and/or the at least one locking element is manually actuatable for an operator regardless of a presence of a battery in the battery interface. Preferably, the power tool comprises a housing. Preferably, a portion of the at least one actuating element and/or the at least one locking element protrudes from the housing, in particular outward from the at least one battery interface. Preferably, the portion of the at least one actuating element and/or the at least one locking element protruding from the housing forms a grip surface. Alternatively, it is conceivable that the portion of the at least one actuating element and/or the at least one locking element protruding from the housing comprises a grip surface or a grip element. By way of the embodiment according to the disclosure, an advantageously high user comfort can be provided, because the actuating element is in particular actuatable even without the battery being inserted by an operator. In particular, an advantageously high level of comfort can be provided with respect to maintenance of the power tool.

It is further proposed that the locking unit comprises a detent mechanism for holding the at least one actuating element and/or the at least one locking element, in particular when actuated manually, in at least two positions. Preferably, the detent mechanism includes a slotted link, particularly a slotted link guide. Preferably, the detent mechanism comprises at least one pin. Preferably, the pin is intended to be guided into the slotted link. The slotted link is preferably designed so that the pin is guided in a circumferential direction. The pin is preferably configured such that the pin is pressed into the slotted link. Preferably, a portion of the detent mechanism, in particular either the slotted link or the pin, is arranged on a fixed portion of the power tool, for example the housing. Preferably, another part of the detent mechanism, in particular either the slotted link or the pin, is arranged on a movable part of the power tool, for example the at least one actuating element or the at least one locking element. Advantageously, the detent mechanism is designed such that a detent function can only be provided by manually actuating the at least one actuating element and/or the at least one locking element. In particular, the detent mechanism is designed such that the detent function is not triggerable by inserting the battery into the at least one battery interface. Preferably, the slotted link is arranged on a level surface. Alternatively, it is conceivable that the detent mechanism is configured analogously to a detent mechanism of a ballpoint pen with a pressure mechanism, wherein the slotted link is arranged on a cylindrical component of the power tool, and wherein the slotted link in particular extends along a helical or stepped groove about a cylindrical axis of rotation of the cylindrical component. By way of the embodiment according to the disclosure, an advantageously high user comfort can be provided, because an operator does not have to hold down the respective element continuously in order to unlock the spindle when manually actuating the actuating element and/or the locking element.

The battery-operated power tool according to the disclosure is not limited to the application and embodiment described above. In particular, the battery-operated power tool according to the disclosure may have a number of individual elements, components, and units that differs from the number specified herein in order to perform the function described herein. Moreover, for the value ranges specified in this disclosure, values lying within the mentioned limits are also provided to be regarded as disclosed and as arbitrarily usable.

### BRIEF DESCRIPTION OF THE DRAWINGS

Further advantages follow from the description of the drawings below. Three exemplary embodiments of the disclosure are shown in the drawing. The drawings, the description, and the claims contain numerous features in combination. A person skilled in the art will also appropriately consider the features individually and combine them into further meaningful combinations.

It shows:

FIG. 1 a schematic illustration of a battery-operated power tool according to the present disclosure with a battery,

FIG. 2 a schematic illustration of an exemplary embodiment of a locking unit with an actuating element configured as a lever and a pulley system,

FIG. 3 a schematic illustration of the exemplary embodiment, wherein the actuating element is manually actuatable for an operator regardless of a presence of the battery in a battery interface,

FIG. 4 a schematic representation of the exemplary embodiment with a latching mechanism,

FIG. 5 a schematic illustration of a further exemplary embodiment of the locking unit with an actuating element configured as a pressure switch and a lever system,

FIG. 6 a schematic illustration of an additional further exemplary embodiment of the locking unit with an actuating element configured as an axial slider.

### DETAILED DESCRIPTION

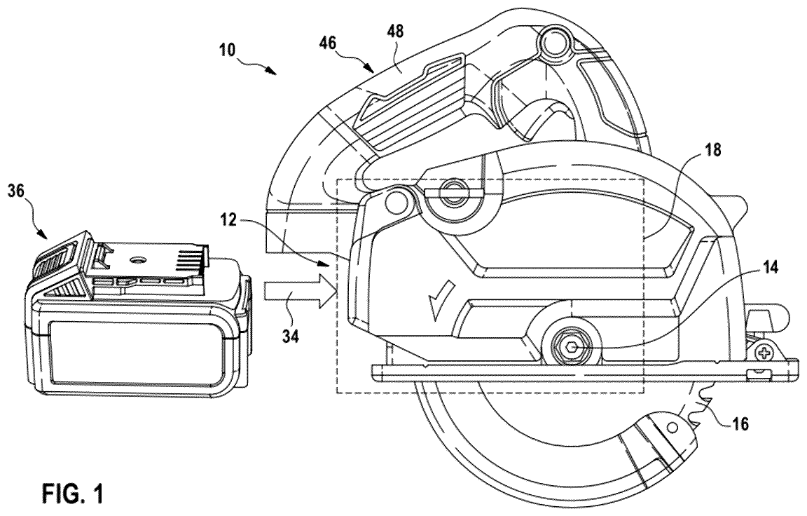

FIG. 1 shows a schematic illustration of a battery-operated power tool 10. The power tool 10 can be configured as a circular saw, in particular as a hand circular saw or a table circular saw or a chop saw or a miter saw or a router or an edge router, or as an angle grinder or the like. In the present case, the power tool 10 is configured as a hand circular saw. The battery-operated power tool 10 may also be configured to operate when wired (not shown) in addition to being battery operated.

The power tool 10 includes a drive unit (not shown). In particular, the drive unit comprises a motor. The power tool 10 comprises a spindle 14. The spindle 14 is intended to receive a tool 16, in the present case a saw blade. In particular, the spindle 14 is provided for a rotationally fixed connection with the tool 16. In the present case, the spindle 14 is part of the drive unit. In particular, the drive unit is provided for driving the spindle 14 indirectly or directly. In particular, the at least one spindle 14 is configured as a motor shaft or as a drive shaft. In particular, the tool 16 is fixed to the at least one spindle 14, advantageously in a rotationally fixed manner. The tool 16 may be fixed to the spindle 14 via a quick-release device or a conventional screw fastening of the power tool 10. In particular, the spindle 14 is provided to transmit a movement, in the present case a rotational movement, of the drive unit to the tool 16 in one operating mode of the power tool 10.

The battery-operated powered power tool 10 comprises a housing 46. In particular, the drive unit is arranged at least substantially within the housing 46. The battery-operated powered power tool 10 comprises a handle 48. In the present case, the handle 48 is part of the housing 46. The handle 48 may include an actuation button for activating the power tool 10, in particular the drive unit. The battery-operated power tool 10 comprises a battery interface 12. In particular, the battery interface 12 is provided to receive a battery 36, advantageously a battery compatible with the power tool 10, for supplying electrical energy. The battery 36 is insertable into the battery interface 12 in a provided insertion direction 34. The battery interface 12 in particular comprises electrical pins (not shown) corresponding to the battery 36.

The power tool 10 comprises a locking unit 18. The locking unit 18 is provided to lock the spindle 14. The locking unit 18 is particularly provided to lock the spindle 14 of the power tool 10 for a tool change and/or maintenance.

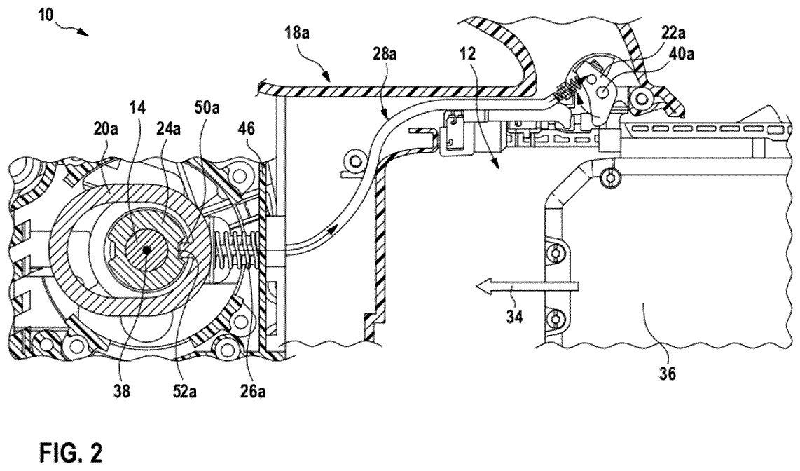

FIGS. 2 to 6 show three different exemplary embodiments of the locking unit 18 of the battery-operated power tool 10 of FIG. 1. The following descriptions and the drawings are substantially limited to the differences between the exemplary embodiments, wherein reference can, in principle, also be made, with respect to identically designated components, in particular with respect to components having the same reference numbers, to the drawing and/or the description of the exemplary embodiment, in particular of FIG. 1. To distinguish the exemplary embodiments of the locking unit(s), the reference characters of FIGS. 2 to 6 are shown with letters a to c. The exemplary embodiment of the battery-operated power tool 10 of FIG. 1 may be combined with any of the exemplary embodiments of the locking unit(s) of FIGS. 2 to 6. The reference number of the exemplary embodiment of the battery-operated power tool 10 in FIG. 1 is therefore not shown with a letter.

FIG. 2 shows a schematic illustration of an exemplary embodiment of a locking unit 18a of the battery-operated power tool 10 of FIG. 1.

The power tool 10 comprises the locking unit 18a for locking the spindle 14. The locking unit 18a comprises a locking element 20a for locking or unlocking the spindle 14. The locking unit 18a comprises an actuating element 22a arranged at the battery interface 12 to move the locking element 20a.

In particular, the locking element 20a is provided to lock the spindle 14 when it is in a lock position. In particular, the locking element 20a is provided to unlock the spindle 14 when it is in an unlock position. The actuating element 22a is particularly provided to move the locking element 20a to the lock position or the unlock position. In FIG. 2, the locking element 20a is in the lock position. The actuating element 22a is provided for moving the locking element 20a to the unlock position upon insertion of the battery 36 into the battery interface 12. The actuating element 22a is provided for moving the locking element 20a to the lock position upon removal of the battery 36 from the battery interface 12. The actuating element 22a is arranged on the battery interface 12 such that the actuating element 22a is actuatable by way of at least one outer surface of the battery 36. In particular, the actuating element 22a protrudes from the battery interface 12 for actuation by way of the battery 36.

The spindle 14 has a spindle axis 38. The locking element 20a is movably, in particular translationally or linearly, mounted in a plane perpendicular to the spindle axis 38. For example, the locking element 20a is guided in a rail or channel. Alternatively, it is conceivable that the locking element 20a is rotatably movably mounted, in particular about a rotational point parallel to the spindle axis 38.

The locking unit 18a comprises a latching element 24a arranged on the spindle 14, corresponding to the locking element 20a. In particular, the latching element 24a is provided, along with the locking element 20a, to lock the spindle 14 when locking element 20a is in the lock position. In the present case, the locking element 20a comprises a base body. The base body preferably has an O-shaped profile in a plane perpendicular to the spindle axis 38, which forms a closed or nearly closed circle or ellipse. The spindle 14 preferably protrudes into the O-shaped profile of the base body, in particular through it. In the present case, the locking element 20a comprises a latch tab 50a. The latch tab 50a is preferably arranged on an inner wall of the O-shaped profile of the base body. In the present case, the locking element 20a comprises guide elements, which are arranged on an outer wall of the O-shaped profile of the base body. The guide elements may be rod-shaped or plate-shaped. In the present case, the base body of the locking element 20a is formed in one piece with the latch tab 50a and the guide elements. Alternatively, it is conceivable that the locking element 20a is configured as a bolt, for example, or as a locking pin, or as a claw, or as a wedge. The latching element 24a comprises an annular base body, which is arranged on the spindle 14 and is particularly arranged concentrically with the spindle 14, relative to the spindle axis 38. In particular, the base body of the locking element 20a at least partially encloses the latching element 24a in a plane perpendicular to the spindle axis 38. Preferably, the latch tab 50a protrudes in the direction of the latching element 24a from the base body of the locking element 20a. The latching element 24a, in the present case, comprises two latch openings 52a. It is conceivable that the latching element 24a comprises more than two latch openings, in particular to provide further latching possibilities. The latch tab 50a of the locking element 20a is provided to lock into at least one of the latch openings 52a of the latching element 24a, in particular in a frictional and/or form-fitting manner, particularly in order to lock the spindle 14. The latching element 24a is arranged in a rotationally fixed manner on the spindle 14, in particular by way of a frictional connection or a form-fitting connection or a material closure connection. Alternatively, it is conceivable that the spindle 14 or the drive unit comprises at least one gear wheel for transmitting movement, wherein the at least one gear wheel forms the latching element 24a.

The locking unit 18a comprises a spring element 26a coupled to the locking element 20a. The spring element 26a is provided to hold locking element 20a in the lock position, especially when the battery 36 has been removed from battery interface 12. The spring element 26a is arranged on the locking element 20a, in particular on one of the guide elements of the locking element 20a. In particular, the spring element 26a is supported via the locking element 20a and a non-movable component of the power tool 10, for example an inner wall of the housing 46. The spring element 26a is provided to move or retain the locking element 20a, particularly by way of a spring force, to/in the lock position upon removal of the battery 36 from the battery interface 12. In the present case, the spring element 26a is configured as a, in particular metallic, spiral spring.

The actuating element 22a is, in the present case, configured as a lever. The actuating element 22a comprises a pivot axis 40a aligned in parallel with the spindle axis 38 of the spindle 14. Alternatively, the actuating element 22a can comprise a pivot axis perpendicularly aligned with the provided insertion direction 34 of the battery 36 in the battery interface 12 and with the spindle axis 38.

The locking unit 18a comprises a pulley system 28a. By way of the pulley system 28a, the actuating element 22a and the locking element 20a are coupled. The pulley system 28a is provided to transmit the movement of the actuating element 22a to the locking element 20a upon movement of the battery 36. In the present case, the pulley system 28a is configured as a Bowden cable. In particular, the pulley system 28a is provided to compress the spring element 26a upon insertion of the battery 36 into the battery interface 12 to move the locking element 20a from the lock position to the unlock position.

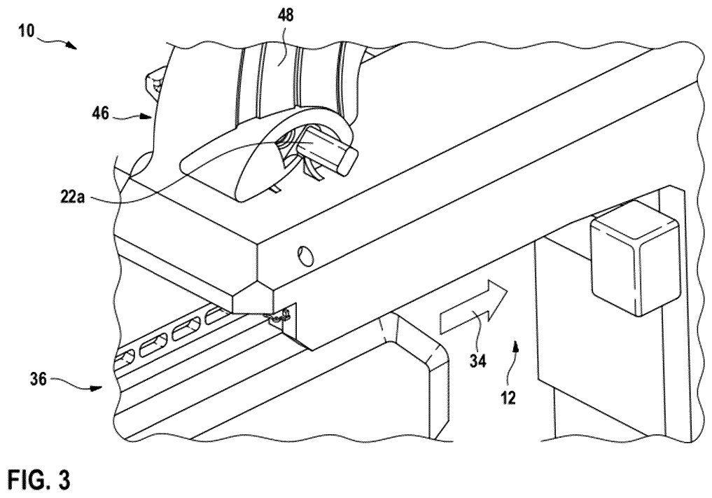

In the present case, the actuating element 22a is configured to be manually actuatable by an operator regardless of a presence of the battery 36 in the battery interface 12, shown in FIG. 3. A portion of the actuating element 22a protrudes from the housing 46. In particular, the portion of the actuating element 22a protrudes outward from the battery interface 12 out of the housing 46, in the present case in an area of the handle 48. In particular, the portion of the actuating element 22a protruding from the housing 46 forms a grip surface for the operator. Alternatively, it is conceivable that the portion of the actuating element 22a protruding from the housing comprises a grip surface or a grip element. Alternatively or additionally, it is conceivable that the locking element 20a is configured to be manually actuatable by an operator regardless of the presence of a battery in the battery interface.

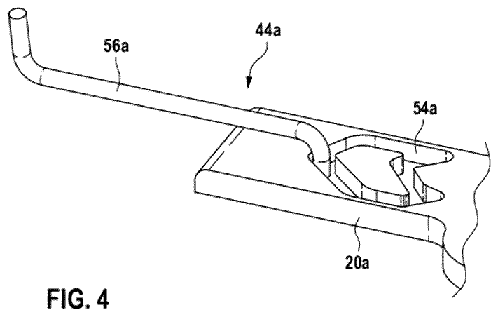

The locking unit 18a comprises a detent mechanism 44a shown in FIG. 4. The detent mechanism 44a is provided to hold the locking element 20a in at least two positions, particularly in the lock position or the unlock position, upon manual actuation. In the present case, the detent mechanism 44a comprises a slotted link 54a, in particular a slotted link guide. In the present case, the detent mechanism 44a comprises at least one pin 56a. In particular, the pin 56a is provided to be guided in the slotted link 54a. The slotted link 54a is designed such that pin 56a is guided into a catch in exactly one circumferential direction. The pin 56a is in particular configured such that a portion of the pin 56a is pushed into the slotted link 54a. In the present case, the pin 56a is supported on a fixed part of the power tool 10, for example, the housing 46. In the present case, the slotted link 54a is arranged on a movable part of the power tool 10a, in particular the locking element 20a, advantageously one of the guide elements of the locking element 20a. In particular, the slotted link 54a is arranged on a planar surface of the locking element 20a. The detent mechanism 44a is designed such that a detent function can only be provided by manually actuating the actuating element 22a and/or the locking element 20a. In particular, the detent mechanism 44a is designed such that the detent function is not triggerable by inserting the battery 36 into the battery interface 12. In particular, the detent mechanism 44a is designed such that the pin 56a, when manually actuated by the actuating element 22a and/or the locking element 20a, may travel a longer distance within the slotted link 54a than when inserting the battery 36 into the battery interface 12. As a result, the detent mechanism 44a is not inadvertently activated by the insertion of the battery 36. In particular, the slotted link 54a comprises ramps (not shown). The ramps particularly form steps within the slotted link 54a to prevent the pin 56a from going backward within the slotted link 54a. Alternatively, it is conceivable that the detent mechanism 44a is configured analogously to a detent mechanism of a ballpoint pen with a pressure mechanism, wherein the slotted link 54a in particular extends along a helical or stepped groove about a cylindrical axis of rotation of a cylindrical component.

For further features of the battery-operated power tool 10, reference is made to the statements about FIG. 1.

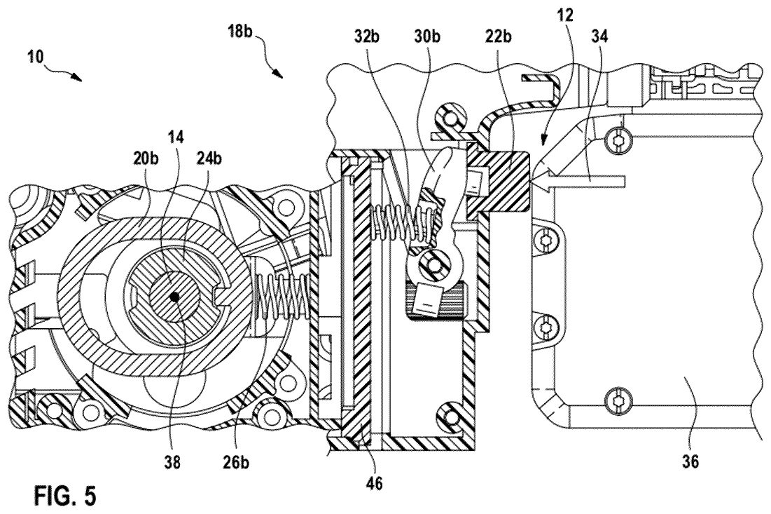

FIG. 5 shows a schematic representation of further exemplary embodiment of a locking unit 18b of the battery-operated power tool 10 of FIG. 1.

The power tool 10 comprises the locking unit 18b for locking the spindle 14. The locking unit 18b comprises a locking element 20b for locking or unlocking the spindle 14. The locking unit 18b comprises an actuating element 22b arranged at the battery interface 12 to move the locking element 20b.

The locking unit 18b comprises a spring element 26b coupled to the locking element 20b. The spring element 26b is provided to hold locking element 20b in a lock position, especially when the battery 36 has been removed from battery interface 12. The spring element 26b is provided to move or retain the locking element 20b, particularly by way of a spring force, to/in the lock position upon removal of the battery 36 from the battery interface 12.

The actuating element 22b is designed as a pushbutton. In particular, the actuating element 22b is designed as a mechanical pressure switch. The actuating element 22b is arranged on the battery interface such that the actuating element is actuatable, in particular pressable, in a provided insertion direction of the battery into the battery interface.

The locking unit 18b comprises a lever system 30b. By way of the lever system 30b, the actuating element 22b and the locking element 20 are coupled. In the present case, the lever system 30b comprises a lever for transmitting movement. Alternatively, the lever system 30b may comprise a plurality of levers, for example at least two levers, which are connected to one another via hinges. The lever of the lever system 30b is supported via a pivot axis parallel to the spindle axis 38. One end of the lever is connected to the actuating element 22b. Another end of the lever is connected to the locking element 20b. The lever system 28b is provided, in the present case, to redirect movement of the actuating element 22b in the insertion direction 34 of the battery 36 upon insertion of the battery 36 into the battery interface 12 so that the locking element 20a is moved contrary to the insertion direction 34.

The locking unit 18b comprises a further spring element 32b. The further spring element 32b is provided to effect a spring force contrary to the provided insertion direction 34 of the battery 36 in the battery interface 12. The further spring element 32b is coupled to the actuating element 22b. In the present case, the spring element is fixed to a non-movable component of the power tool 10, in particular a part of the housing 46, and the lever system 30b, in particular the lever of the lever system 30b. In the present case, the further spring element 32b is configured as a, in particular, metallic, spiral spring or the like.

For further features of the battery-operated power tool 10, reference is made to the statements about FIG. 1 and/or FIGS. 2 to 4.

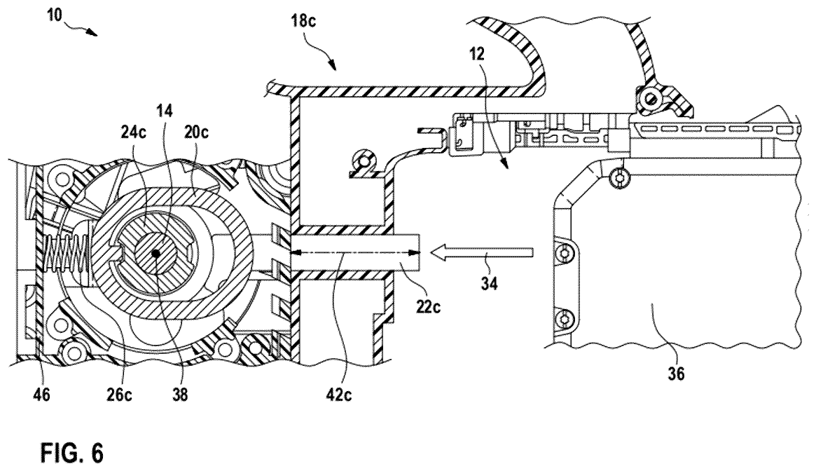

FIG. 6 shows a schematic representation of an additional further exemplary embodiment of a locking unit 18c of the battery-operated power tool 10 of FIG. 1.

The power tool 10 comprises the locking unit 18c for locking the spindle 14. The locking unit 18c comprises a locking element 20c for locking or unlocking the spindle 14. The locking unit 18c comprises an actuating element 22c arranged at the battery interface 12 to move the locking element 20c.

In particular, the locking element 20c is provided to lock the spindle 14 when it is in a lock position. In particular, the locking element 20c is provided to unlock the spindle 14 when it is in an unlock position. The actuating element 22c is particularly provided to move the locking element 20c to the lock position or the unlock position. The actuating element 22c is provided for moving the locking element 20c to the unlock position upon insertion of the battery 36 into the battery interface 12. The actuating element 22c is provided for moving the locking element 20c to the lock position upon removal of the battery 36 from the battery interface 12. The actuating element 22c is arranged on the battery interface 12 such that the actuating element 22c is actuatable by way of at least one outer surface of the battery 36. In particular, the at least one actuating element 22c at least partially protrudes from the battery interface 12 for actuation by way of the battery 36.

The locking unit 18c comprises a spring element 26c coupled to the locking element 20c. The spring element 26c is arranged on the locking element 20c. In particular, the spring element 26c is supported via the locking element 20c and a non-movable component of the power tool, for example an inner wall of the housing 46. The spring element 26c is provided to move or retain the locking element 20c, particularly by way of a spring force, to/in the lock position upon removal of the battery 36 from the battery interface 12. When inserting the battery into the battery interface, the actuating element is provided to compress the spring element 26c and move the locking element to the unlock position.

In the present case, the locking element 22c and the actuating element 22c are rigidly connected, and are in particular formed in one piece. The actuating element 22c is, in the present case, configured as an axial slider. The actuating element 22c is movably mounted in an axis 42c parallel to the provided insertion direction 34 of the battery 36 in the battery interface 12. In particular, the actuating element 22c is mounted in a plane perpendicular to the spindle axis 38. In particular, the axial slider is movably mounted on a rail (not shown). In particular, the actuating element 22c is provided to directly move the locking element 20c.

For further features of the battery-operated power tool 10, reference is made to the statements about FIG. 1 and/or FIGS. 2 to 4 and/or FIG. 5.

What is claimed is:

1. A battery-operated power tool, comprising:
at least one battery interface;
at least one spindle configured to receive a tool, and
at least one locking unit configured to lock the at least one spindle,
wherein the locking unit includes at least one locking element configured to lock or release the at least one spindle, and
wherein the locking unit further includes at least one actuating element arranged at the battery interface and configured to move the at least one locking element.

2. The battery-operated power tool according to claim 1, wherein the locking unit further includes at least one latching element corresponding to the at least one locking element.

3. The battery-operated power tool according to claim 1, wherein the locking unit further includes at least one spring element coupled to the at least one locking element and configured to hold the at least one locking element in a lock position.

4. The battery-operated power tool according to claim 1, wherein the locking unit further includes a pulley system and/or a lever system, by way of which the at least one actuating element and the at least one locking element are coupled.

5. The battery-operated power tool according to claim 1, wherein the at least one locking element and the at least one actuating element are rigidly connected.

6. The battery-operated power tool according to claim 1, wherein the locking unit further includes at least one further spring element, which is configured to effect a spring force contrary to a provided insertion direction of a battery in the battery interface.

7. The battery-operated power tool according to claim 1, wherein the at least one actuating element is configured as a lever and includes a pivot axis aligned in parallel to a spindle axis of the spindle or includes a pivot axis aligned perpendicularly to a provided insertion direction of a battery in the battery interface and to the spindle axis.

8. The battery-operated power tool according to claim 1, wherein the at least one actuating element is configured as an axial slider, which is movably mounted in an axis parallel to a provided insertion direction of a battery in the battery interface.

9. The battery-operated power tool according to claim 1, wherein the at least one actuating element is configured as a pressure switch.

10. The battery-operated power tool according to claim 1, wherein the at least one actuating element and/or the at least one locking element is/are manually actuatable for an operator independent of a presence of a battery in the battery interface.

11. The battery-operated power tool according to claim 10, wherein the locking unit further includes a detent mechanism configured to hold the at least one actuating element and/or the at least one locking element in at least two positions.

12. The battery-operated power tool according to claim 1, wherein the battery-operated power tool is a circular saw.

13. The battery-operated power tool according to claim 1, wherein the at least one locking element and the at least one actuating element are formed from one piece.
